(19) United States
(12) Patent Application Publication
(10) Pub. No.: US 2012/0042483 A1
(43) Pub. Date: Feb. 23, 2012

(54) Method for forming hook elements directly on a fabric substrate, apparatus for performing the method, and article manufactured by the method

(75) Inventor: Allen Cheng, Chang Hwa Hsien (TW)

(73) Assignee: Taiwan Paiho Limited, Chang Hwa Hsien (TW)

(21) Appl. No.: 12/926,418

(22) Filed: Nov. 17, 2010

(30) Foreign Application Priority Data
Aug. 18, 2010 (TW) 099127571

(51) Int. Cl. A44B 18/00; D01D 5/253; B28B 11/08

(52) U.S. Cl. 24/442; 264/167; 425/335

(57) ABSTRACT

The present invention provides a novel method for forming hook elements directly on a fabric substrate. In the method of present invention, melted plastic material is injected into cavities of a molding roll; excessive plastic material is scraped from a peripheral surface of the molding roll with a scrapper; a web of fabric substrate is bonded to the hooks molded in the cavities through a thermo-pressing process by using a thermo-pressing roll; and the combined hooks and fabric substrate is cooled and removed from the molding roll to form a fabric material with a hook strap. The present invention also provides an apparatus for performing the method of the present invention.

### FIELD OF THE INVENTION

The present invention relates generally to mechanical fasteners, and more specifically to a method for forming hooks directly on a fabric substrate, apparatus for performing the method, and article manufactured by the method.

### BACKGROUND OF THE INVENTION

A hook-and-loop type fastener is a well know mechanical fastener and wildly used in a variety of fields that need to fasten two separate parts together, such as garment, hats/caps, shoes, personal care product (such as diapers) etc., because of its easy engaging/disengaging characteristic. The hook-and-loop type fastener mainly consists of a hook strap on which an array of hooks are formed and a loop member on which a plurality of loops are formed to be engage with the hooks of the hook strap. In use, the hook strap 10, which includes a sheet of backing 11 and a plurality of hooks 12 integrally formed with the backing 11) bonded to a fabric substrate 14 with a layer of adhesive 13 to form a fabric material with a hook strap, as illustrated in FIG. 1.

Although traditional fabric materials with a hook strap made by above-mentioned process may provide fastening effect in some applications, they still have shortcomings. For instance, because traditional fabric materials with a hook strap use an adhesive layer to bond the hook strap and the fabric substrate together, the overall thickness is inevitably increased and so is the manufacture cost. Additionally, because of the layered structure of the traditional fabric material with a hook strap its suppleness is too stiff in applications that suppleness fabric material with a hook strap is critical. For instance, when utilized in a diaper the fabric material with a hook strap usually is used as a fastening member to keep the diaper in place about the wearer. Therefore, if the fabric material with a hook strap does not have sufficient suppleness, the wearer of the diaper may feel uncomfortable and even may leave a mark on the skin of the wearer.

In view of the shortcomings of traditional fabric material with a hook strap described above, there exists a need for a fabric material having hook elements that possess a fastening function and a sufficient suppleness, and a method and an apparatus for making the same.

### SUMMARY OF THE INVENTION

The object of the present invention is to provide a fabric material having hook elements that possess a fastening function and a sufficient suppleness so as to overcome the problems of existing fabric material with a hook strap, a method and an apparatus for making such fabric material.

One aspect of the present invention provides a method for forming hook elements directly on a fabric substrate, the method comprising: providing a rotatable molding roll having a cooling device disposed therein and a number of circumferential grooves formed in a peripheral surface thereof, each groove having a plurality of cavities formed in a bottom thereof along the groove with an interval between adjacent cavities; providing melted plastic material to the peripheral surface of the molding roll with pressure to fill the grooves and cavities with the melted plastic material; scrapping excessive plastic material from the peripheral surface of the molding roll; passing a web of fabric substrate through a nip formed by the peripheral surface of the molding roll and a peripheral surface of a thermo-pressing roller, wherein the thermo-pressing roller is disposed radially against the molding roll such that a pressure is applied to the fabric substrate, and is heated to a temperature to allow a portion of the plastic material in the cavities and grooves at the proximity of the peripheral surface of the molding roll and contacting the fabric substrate to be in a softened and fusible state so as to be fused to the fabric substrate and to thereby keep the fabric substrate attached to the peripheral surface of the molding roll; cooling the thermo-pressed fabric substrate so as to allow the plastic material in the cavities and grooves to be solidified to from the hook elements and to be fixed to the fabric substrate; and separate the fabric substrate on which a plurality of hook elements are formed from the peripheral surface of the molding roll.

According to one embodiment of the present invention, the grooves are formed in parallel along the peripheral surface of the molding roll. Additionally, the grooves may be formed in the peripheral surface of the molding roll in straight-line form, wave form, or zigzag form. The cavities in each groove may be aligned with the cavities in adjacent grooves or may be offset from each other. The fabric substrate comprises a non-woven fabric.

Another aspect of the present invention provides an apparatus for forming hook elements directly on a fabric substrate, the apparatus comprising: a molding roll rotatable in a direction having a cooling device disposed therein and a number of circumferential grooves formed in a peripheral surface thereof, each groove having a plurality of cavities formed in a bottom thereof along the groove with an interval between adjacent cavities; an extruder having a nozzle for providing melted plastic material to the peripheral surface of the molding roll with pressure, the nozzle being disposed close to the peripheral surface of the molding roll with a gap formed therebetween; a scrapper disposed at a position downstream from the extruder in the molding roll rotating direction and an edge thereof contacting the peripheral surface of the molding roll; a thermo-pressing roller disposed against the molding roll such that a nip is formed between the peripheral surface of the molding roll and a peripheral surface of the thermo-pressing roller and at a position downstream from the scrapper in the molding roll rotating direction, wherein the peripheral surface of the thermo-pressing roller is heated to a temperature that is able to allow the plastic material in a state of being fusible under pressure; a fabric substrate feeding roller for providing a web of fabric substrate through the nip between the molding roll and the thermo-pressing roller so as to allow a portion of the plastic material in the cavities and grooves at the proximity of the peripheral surface of the molding roll and contacting the fabric substrate in a fusible state so as to be fused to the fabric substrate and to thereby keep the fabric substrate attached to the peripheral surface of the molding roll; external cooling means disposed about the peripheral surface of the molding roll at a position downstream from the thermo-pressing roller in the molding roll rotating direction for cooling the fabric substrate attached to the molding roll so as to allow the plastic material in the cavities and grooves to be solidified to from the hook elements and to be fixed to the fabric substrate; and a striping device for separating the fabric substrate on which a plurality of hook elements are formed from the peripheral surface of the molding roll.

The nip between the molding roll and the thermo-pressing roller may be adjusted by moving the thermo-pressing roller relative to the molding roll so a to make the nip slightly smaller than the thickness of the fabric substrate.

Still another aspect of the present invention provides a fabric material having hook elements that is manufactured by the method of the present invention, the fabric material comprising a fabric substrate and a plurality of hook strips formed directly to the fabric substrate, wherein each of the hook strips includes a number of integrally formed hook elements and adjacent hook elements in the same hook strip are connected by plastic material strips slighter wider than the hook elements, and there is no plastic material between adjacent hook strips.

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings, wherein:

FIG. 1 is a schematic perspective view of a traditional hook strap;

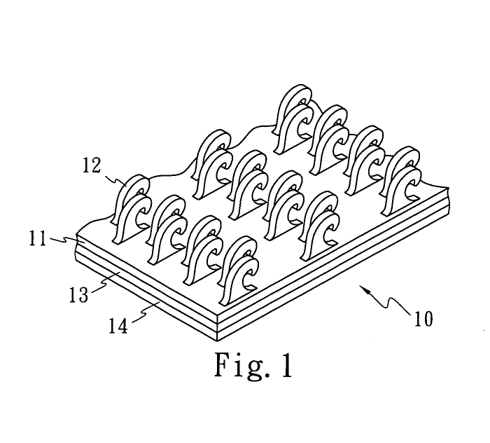

FIG. 2 is a schematic plane view showing an apparatus for manufacturing a fabric material having hook elements according to one embodiment of the present invention;

FIG. 3 is a schematic perspective view showing a molding roll used in the apparatus of FIG. 2 according to an embodiment of the present invention; and

FIGS. 4a, 4b, and 4c are the top view, side view and end view of the fabric material having hook elements according to one embodiment of the present invention, respectively.

### DETAILED DESCRIPTION OF THE INVENTION

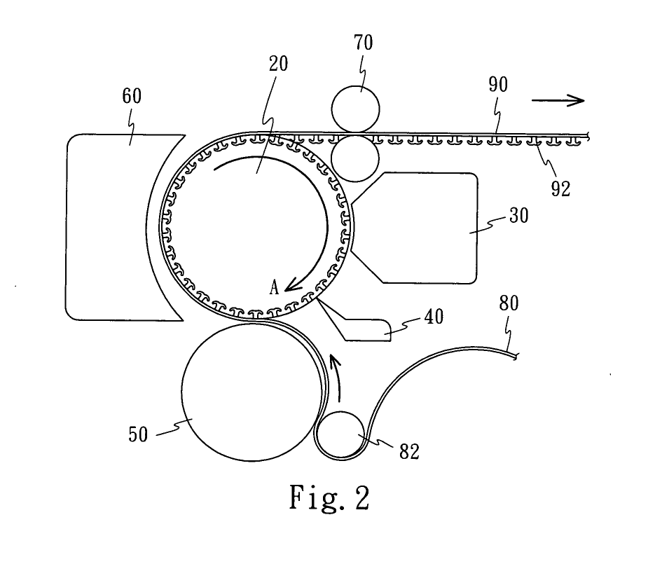

Referring now to embodiments illustrated in FIGS. 2-4 to describe a fabric material having hook elements, a method and an apparatus for manufacturing the fabric material of the present invention.

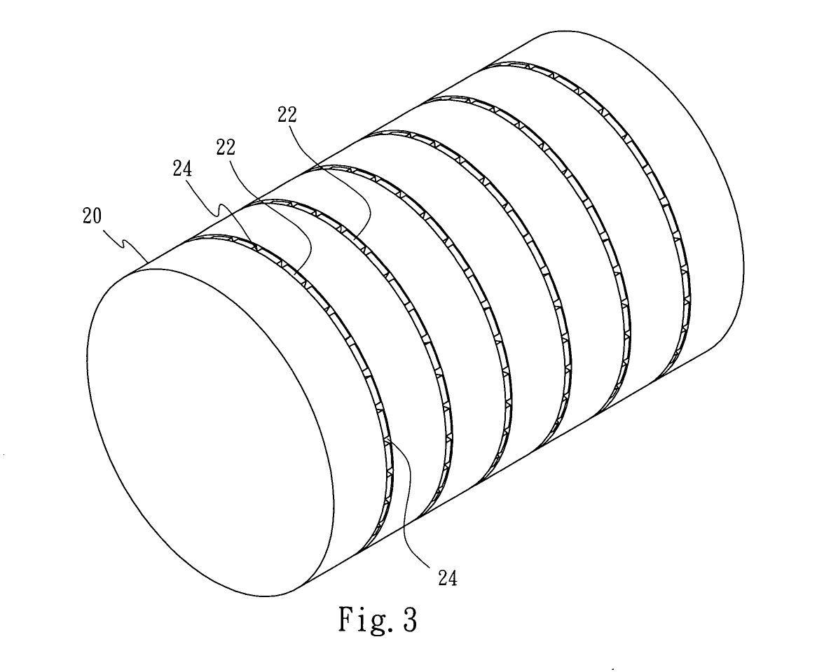

FIG. 2 is a schematic plane view showing an apparatus 100 for manufacturing a fabric material having hook elements according to one embodiment of the present invention. The apparatus 100 mainly includes a molding roll 20 rotatable in one direction, an extruder 30, a scrapper 40, a thermo-pressing roller 50, a fabric substrate feeding roller 82, an external cooling device 60 and a pair of stripping rollers 70. As shown in FIG. 3, a number of parallel circumferential grooves 22 are formed in a peripheral surface of the molding roll 20. Each of the grooves 22 has a plurality of cavities 24 formed in a bottom thereof along the groove 22 with an interval between adjacent cavities 24. Each of the cavities 24 has a shape corresponding to a desired shape of a hook element, such as a single-hook shape, a dual-hook shape, mushroom-head shape, or the like. In the embodiment illustrated in FIG. 3, the cavity 24 has a shape corresponding to a dual-hook shape hook element. Further, in the embodiment illustrated in FIG. 3, the grooves 22 are straight-line grooves, however, in other embodiments, the grooves 22 may be grooves of other forms, such as wave form, zigzag form or the like. Additionally, a cooling water circulation system (not shown) may be disposed within the molding roll 20 for cooling the plastic material filled in the cavities 24.

As illustrated in FIG. 2, the extruder 30 includes a nozzle for ejecting melted plastic material with pressure. The nozzle is disposed radially opposed and intimately close to the peripheral surface of the molding roll 20 to have a small gap formed therebetween. The scrapper 40 is disposed at a position downstream from the extruder 30 in a rotation direction of the molding roll 20 illustrated in FIG. 2 by an arrow A. Additionally, an edge of the scrapper 40 is in contact with the peripheral surface of the molding roll 20 for scrapping excessive plastic material from peripheral surface of the molding roll 20.

The thermal-pressing roller 50 is disposed at a position downstream from the scrapper in the rotation direction A of the molding roll 20 with a peripheral surface thereof radially opposed and intimately close to the peripheral surface of the molding roll 20 to have a nip formed therebetween. The fabric substrate feeding roller 82 is disposed to supply a web of fabric substrate 80 through the nip. Preferably, the nip may be adjusted by moving the thermo-pressing roller 50 radially relative to the molding roll 20 so a to make the nip slightly smaller than the thickness of the fabric substrate 80 and thus a pressure in the thickness direction of the fabric substrate 80 may be applied to the fabric substrate 80. The external cooling device 60 may be a cooling fan and is disposed at a position downstream from the thermo-pressing roller 50 in a the rotation direction A of the molding roll 20 for blowing a cool air stream toward the peripheral surface of the molding roll 20. The stripping rollers 70 are disposed at a position downstream from the external cooling device 60 in a the rotation direction A of the molding roll 20.

When manufacturing a fabric material having hook elements with the apparatus 100 described above, a thermoplastic material (for example, polyethylene) is firstly supplied to the extruder 30 and is heated up to 235° C. to make the thermoplastic material in a melted state. The melted thermoplastic material is then ejected through the nozzle of the extruder 30 onto the outer periphery surface of the rotational molding roller 20 and into the grooves 22 and cavities 24. The thermoplastic material in the grooves 22 and cavities 24 is cooled by the cooling water circulation system and gradually solidified. Then, with the rotation of the molding roll 20, excessive thermoplastic material on the peripheral surface of the molding roll 20 is scraped off from the peripheral surface of the molding roll 20 by the scrapper 40. In other words, after the scrapper 40 scrapping the peripheral surface of the molding roll 20, thermoplastic material only exists in the grooves 22 and cavities 24, and no thermoplastic material on the peripheral surface of the molding roll 20. This is completely contrary to the traditional method for extrusion molding a hook strap in which a layer of thermoplastic material is left on the peripheral surface of a molding roll to from a backing of the hook strap.

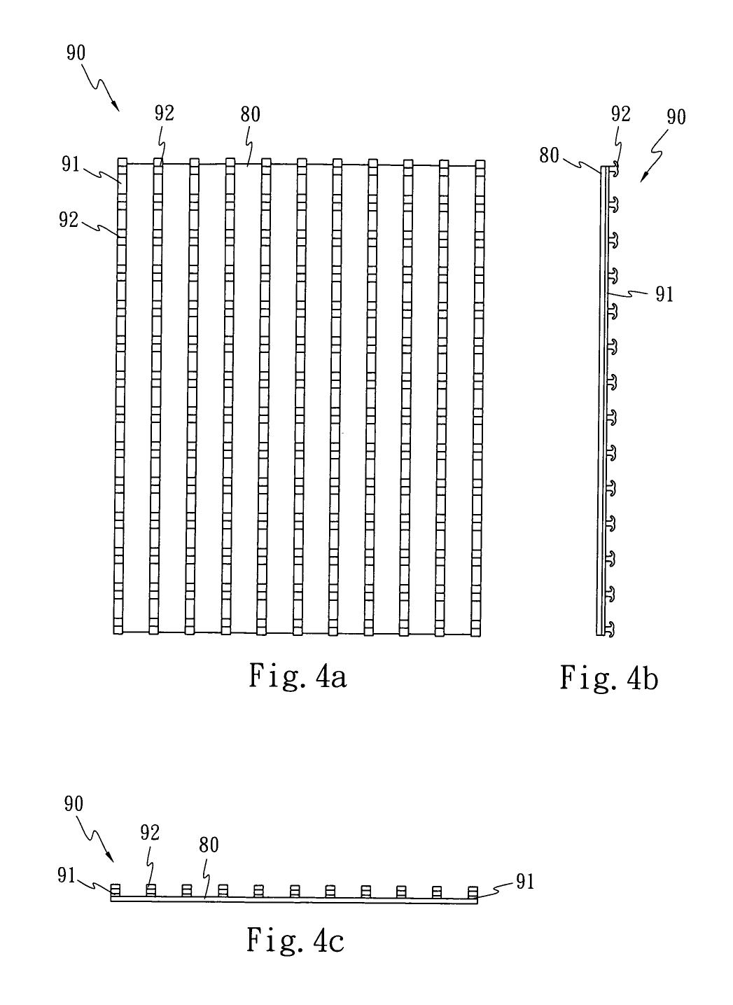

Next, passing a web of fabric substrate 80, in this embodiment a non-woven fabric, through the nip between the molding roll 20 and the thermo-pressing roller 50. By heating the peripheral surface of the thermo-pressing roller 50 to a proper temperature (such as, in the case the thermoplastic material is a polyethylene, the temperature is about 235° C.), a portion of the thermoplastic material in the cavities 24 and grooves 22 at the proximity of the peripheral surface of the molding roll 20 and contacting the fabric substrate 80 turns into a softened and fusible state, and with the pressure applied by the thermo-pressing roller 50 this portion of the thermoplastic material may penetrate into fabric substrate 80 and thus combine the thermoplastic material in the cavities 24 and grooves 22 with the fabric substrate 80, and the fabric substrate 80 is thus attached on the peripheral surface of the molding roll 20 and rotate therewith. Then, the thermo-pressed fabric substrate 80 is cooled by the cool air stream blew toward it by the cooling fan 60 while rotating with the molding roll 20 so as to solidify the thermoplastic material penetrated into the fabric substrate 80 to thereby firmly fixing the hook elements formed in the cavities 24 to the fabric substrate 80. Then, the fabric substrate 80 on which a plurality of hook elements are formed is separated from the molding roll 20 by the stripping rollers 70 to form a fabric material 90 having hooks (see FIG. 4).

FIGS. 4a, 4b, and 4c are the top view, side view and end view of the fabric material 90 having hook elements according to one embodiment of the present invention, respectively. As shown in FIG. 4a-4c, the fabric material 90 includes a fabric substrate 80 and a plurality of hook strips 91 that are directly formed thereon. Each of the hook strip 91 includes a number of integrally formed hook elements 92. Adjacent hook elements 92 in the same hook strip 91 are connected by thermoplastic material strips that is slighter wider than the hook elements 92. There is no plastic material between adjacent hook strips 91 and thus the fabric material 90 may have a great suppleness.

The present invention utilizes a technique that is completely opposite to the traditional technique for forming a fabric material having hooks. Specifically, in the traditional technique, a sheet of hook strap is separately injection molded and then bonded to a fabric substrate through an adhesive layer. The present invention on the other hand forms the hook elements directly onto the fabric substrate. Most importantly, because the fabric material made by the present invention does not have a hook strap that covers the entire surface of the fabric substrate, the fabric material provided by the present invention not only has fastening functionality but also has great suppleness.

Although the present invention has been described above according to preferred embodiments of the fabric material, the apparatus and method illustrated in the accompanying drawings, this does not mean that the scope of the present invention is limited to specific configurations of the fabric material and apparatus, and the steps or sequences of the method described above. In fact, there exist various modifications and variations under the principle and spirit disclosed above. For instance, although it is illustrated in FIG. 3 that the cavities 24 in a groove 22 are aligned with the cavities 24 in adjacent grooves 22, in other embodiments, the cavities 24 in one groove 22 may be offset from the cavities in adjacent grooves 22, for instance, arranged in a interlaced manner.

It will be apparent to people skilled in this art that many modifications can be made to the disclosed structures without departing from the true scope of the invention defined by the appended claims. Therefore, it is the intent of the appended claims to cover all such variations and modifications as come within the spirit and scope of this invention.

What is claimed is:

1. A method for forming hook elements directly on a fabric substrate, the method comprising the steps of:
providing a rotatable molding roll having a cooling device disposed therein and a number of circumferential grooves formed in a peripheral surface thereof, each groove having a plurality of cavities formed in a bottom thereof along the groove with an interval between adjacent cavities;
providing melted plastic material to the peripheral surface of the molding roll with pressure to fill the grooves and cavities with the melted plastic material;
scrapping excessive plastic material from the peripheral surface of the molding roll;
passing a web of fabric substrate through a nip formed by the peripheral surface of the molding roll and a peripheral surface of a thermo-pressing roller, wherein the thermo-pressing roller is disposed radially against the molding roll such that a pressure is applied to the fabric substrate, and is heated to a temperature to allow a portion of the plastic material in the cavities and grooves at the proximity of the peripheral surface of the molding roll and contacting the fabric substrate to be in a softened and fusible state so as to be fused to the fabric substrate and to thereby keep the fabric substrate attached to the peripheral surface of the molding roll;
cooling the thermo-pressed fabric substrate so as to allow the plastic material in the cavities and grooves to be solidified to from the hook elements and to be fixed to the fabric substrate; and
separate the fabric substrate on which a plurality of hook elements are formed from the peripheral surface of the molding roll.

2. A method according to claim 1, wherein the grooves are formed in parallel along the peripheral surface of the molding roll.

3. A method according to claim 2, wherein the grooves are formed in the peripheral surface of the molding roll in a straight-line form.

4. A method according to claim 2, wherein the grooves are formed in the peripheral surface of the molding roll in a wave form or a zigzag form.

5. A method according to claim 1, wherein the cavities in each groove are aligned with the cavities in adjacent grooves.

6. A method according to claim 1, wherein the cavities in each groove are offset from the cavities in adjacent grooves.

7. A method according to claim 1, wherein the fabric substrate comprises a non-woven fabric.

8. An apparatus for forming hook elements directly on a fabric substrate comprising:
a molding roll rotatable in a direction having a cooling device disposed therein and a number of circumferential grooves formed in a peripheral surface thereof, each groove having a plurality of cavities formed in a bottom thereof along the groove with an interval between adjacent cavities;
an extruder having a nozzle for providing melted plastic material to the peripheral surface of the molding roll with pressure, the nozzle being disposed close to the peripheral surface of the molding roll with a gap formed therebetween;
a scrapper disposed at a position downstream from the extruder in the molding roll rotating direction and an edge thereof contacting the peripheral surface of the molding roll;
a thermo-pressing roller disposed against the molding roll such that a nip is formed between the peripheral surface of the molding roll and a peripheral surface of the thermo-pressing roller and at a position downstream from the scrapper in the molding roll rotating direction, wherein the peripheral surface of the thermo-pressing roller is heated to a temperature that is able to allow the plastic material in a state of being fusible under pressure;
a fabric substrate feeding roller for providing a web of fabric substrate through the nip between the molding roll and the thermo-pressing roller so as to allow a portion of the plastic material in the cavities and grooves at the proximity of the peripheral surface of the molding roll and contacting the fabric substrate in a fusible state so as to be fused to the fabric substrate and to thereby keep the fabric substrate attached to the peripheral surface of the molding roll;
external cooling means disposed about the peripheral surface of the molding roll at a position downstream from the thermo-pressing roller in the molding roll rotating direction for cooling the fabric substrate attached to the molding roll so as to allow the plastic material in the cavities and grooves to be solidified to from the hook elements and to be fixed to the fabric substrate; and
a striping device for separating the fabric substrate on which a plurality of hook elements are formed from the peripheral surface of the molding roll.

9. An apparatus according to claim 8, wherein the nip between the molding roll and the thermo-pressing roller can be adjusted by moving the thermo-pressing roller relative to the molding roll so a to make the nip slightly smaller than the thickness of the fabric substrate.

10. An apparatus according to claim 8, wherein the grooves are formed in parallel along the peripheral surface of the molding roll.

11. An apparatus according to claim 10, wherein the grooves are formed in the peripheral surface of the molding roll in a straight-line form.

12. An apparatus according to claim 10, wherein the grooves are formed in the peripheral surface of the molding roll in a wave form or a zigzag form.

13. An apparatus according to claim 8, wherein the cavities in each groove are aligned with the cavities in adjacent grooves.

14. An apparatus according to claim 8, wherein the cavities in each groove are offset from the cavities in adjacent grooves.

15. An apparatus according to claim 8, wherein the fabric substrate comprises a non-woven fabric.

16. A fabric material having hook elements that is manufactured by the method according to claim 1, the fabric material comprising: a fabric substrate and a plurality of hook strips formed directly to the fabric substrate, wherein each of the hook strips includes a number of integrally formed hook elements and adjacent hook elements in the same hook strip are connected by plastic material strips slighter wider than the hook elements, and there is no plastic material between adjacent hook strips.

17. A fabric material having hook elements that is manufactured by the method according to claim 2, the fabric material comprising: a fabric substrate and a plurality of hook strips formed directly to the fabric substrate, wherein each of the hook strips includes a number of integrally formed hook elements and adjacent hook elements in the same hook strip are connected by plastic material strips slighter wider than the hook elements, and there is no plastic material between adjacent hook strips.

18. A fabric material having hook elements that is manufactured by the method according to claim 3, the fabric material comprising: a fabric substrate and a plurality of hook strips formed directly to the fabric substrate, wherein each of the hook strips includes a number of integrally formed hook elements and adjacent hook elements in the same hook strip are connected by plastic material strips slighter wider than the hook elements, and there is no plastic material between adjacent hook strips.

19. A fabric material having hook elements that is manufactured by the method according to claim 4, the fabric material comprising: a fabric substrate and a plurality of hook strips formed directly to the fabric substrate, wherein each of the hook strips includes a number of integrally formed hook elements and adjacent hook elements in the same hook strip are connected by plastic material strips slighter wider than the hook elements, and there is no plastic material between adjacent hook strips.

20. A fabric material having hook elements that is manufactured by the method according to claim 5, the fabric material comprising: a fabric substrate and a plurality of hook strips formed directly to the fabric substrate, wherein each of the hook strips includes a number of integrally formed hook elements and adjacent hook elements in the same hook strip are connected by plastic material strips slighter wider than the hook elements, and there is no plastic material between adjacent hook strips.

21. A fabric material having hook elements that is manufactured by the method according to claim 6, the fabric material comprising: a fabric substrate and a plurality of hook strips formed directly to the fabric substrate, wherein each of the hook strips includes a number of integrally formed hook elements and adjacent hook elements in the same hook strip are connected by plastic material strips slighter wider than the hook elements, and there is no plastic material between adjacent hook strips.

22. A fabric material having hook elements that is manufactured by the method according to claim 7, the fabric material comprising: a fabric substrate and a plurality of hook strips formed directly to the fabric substrate, wherein each of the hook strips includes a number of integrally formed hook elements and adjacent hook elements in the same hook strip are connected by plastic material strips slighter wider than the hook elements, and there is no plastic material between adjacent hook strips.
